(19) United States
(12) Patent Application Publication
(10) Pub. No.: US 2026/0037733 A1
(43) Pub. Date: Feb. 5, 2026

(54) SYSTEM AND METHOD FOR MANAGING POLICIES FOR CAPABILITY INTENTS OF CAPABILITIES ASSOCIATED WITH ARTIFICIAL INTELLIGENCE PRODUCTIVITY TOOL RESPONSES EXECUTING ON AN INFORMATION HANDLING SYSTEM

(71) Applicant: Dell Products LP, Round Rock, TX (US)

(72) Inventors: Srikanth Kondapi, Austin, TX (US); Daniel L. Hamlin, Round Rock, TX (US); Balasingh P. Samuel, Round Rock, TX (US)

(73) Assignee: Dell Products LP, Round Rock, TX (US)

(21) Appl. No.: 18/791,660

(22) Filed: Aug. 1, 2024

(51) Int. Cl. G06F 40/30

(52) U.S. Cl. CPC G06F 40/30

(57) ABSTRACT

An information handling system includes a hardware processor with the hardware processor executing computer-readable program code instructions of an intent dependency determination software application to receive one or more capability intent action policies describing controls for execution of the capability intent action policies to be implemented at the information handling system and identify capability dependencies of affected capabilities of each of a plurality of AI productivity tool-enablable software applications or AI productivity tool modules executable at the information handling system. The hardware processor executing computer-readable program code instructions of a policy control managing subagent to transmit the capability intent action policies to the AI productivity tool-enablable software applications or AI productivity tool modules for application of the capability intent action policies to any capability intent actions executed in response to a received user-query input at the information handling system.

### FIELD OF THE DISCLOSURE

The present disclosure generally relates to execution of computer-readable program code instructions for one or more artificial intelligence (AI) productivity tools generating responsive actions to user-query inputs. The present disclosure more specifically relates systems and methods of implementing capability intent action policies in an information handling system for managing the capabilities of one or more AI productivity tool-enablable software applications on an information handling system.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of one or more workspace productivity applications or other application such as for teleconferencing, word processing, sales systems, business software, gaming applications, or the like. Further, the information handling system may include an on the box (OTB) artificial intelligence (AI) productivity tool employing machine learning (ML) models stored locally at the information handling system, as installed by a manufacturer of the information handling system, for optimizing user productivity and information handling system performance.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system that includes computer-readable program code instructions of an AI productivity tool and an to select among a plurality of AI productivity tool-enablable software applications for software services, operations, or responses of those AI productivity tool-enablable software applications as controlled under one or more capability intent action policies according to an embodiment of the present disclosure;

FIG. 2 is a graphic and block diagram illustrating an information handling system that includes computer-readable program code instructions an AI productivity tool module to select among a plurality of AI productivity tool-enablable software applications for software services, operations, or responses of those AI productivity tool-enablable software applications as controlled under one or more capability intent action policies according to another embodiment of the present disclosure; and

FIG. 3 is a flow diagram showing a method 300 implementing capability intent action policies in an information handling system executing computer-readable program code instructions of an AI productivity tool according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Information handling systems, including computers, mobile computers, and smart phones are increasingly employing artificial intelligence (AI) productivity tools to optimize user productivity and performance of the information handling systems. Examples of such artificial intelligence methodologies includes chatbots to simulate conversations between the information handling system and the user. In an example embodiment of the present disclosure, an AI productivity tool may be used to trigger changes in firmware or hardware (e.g., changing display or power settings), software, or processes of one or more AI productivity tool-enablable software applications (e.g., send an e-mail or text message, schedule a meeting). Various machine learning models may be used to support such functionality, including automatic speech recognition (ASR) models, text embedding models, and similarity search models that may work in combination with one another to identify a capability intent action that may be taken by an AI productivity tool enablable software application as requested within a received user-query input according to embodiments herein. For example, an existing AI productivity tool may be capable of determining a user's intent for correlation to a capability intent action the user is requesting to be performed within a user-query input, and matching that determined query intent with a capability intent known to be achievable, based on published or established capabilities by a particular of one or more AI productivity tool-enablable software applications executing at the information handling system. In some AI productivity tools, once the AI productivity tool-enablable software application capable of performing the user-requested capability intent action within the user-query input is identified, the AI productivity tools may identify an application programming interface (API) call that, when executed, may cause the AI productivity tool-enablable software application associated with the identified capability to perform that capability.

Prior to such a process and prior to a user providing such a user-query input into an AI productivity tool, each of a plurality of AI productivity tool-enablable software applications have an application programming interface (API) and may register with the existing AI productivity tool a list of capabilities achievable by that AI productivity tool-enablable software application. In some embodiments, that list of capabilities includes a list or library of API calls associated with each of those capabilities that the AI productivity tools can use to cause the AI productivity tool-enablable software applications to execute such capabilities. Such a registration of capabilities at an AI productivity tool may not be controllable by an internet technology decision maker (ITDM) that may be hired by an enterprise to help manage the information handling systems operated and managed within an enterprise. An ITDM may need control over all, or some aspects of behaviors related to the performance of the individual information handling systems within the enterprise. This is extended to those operations of the individual information handling systems that include the AI productivity tools and AI productivity tool-enablable software applications that are operated to provide responsive capability intent actions, software services, or other responses to a user when the user has provided user-query input to the information handling system.

The present specification describes systems and methods of implementing capability intent action policies in an information handling system among a plurality of enterprise-managed information handling systems. In an example embodiment, an information handling system may include a hardware processor with the hardware processor executing computer-readable program code instructions of an intent dependency determination software application to receive one or more capability intent action policies describing if and how capability intent actions will be implemented at the information handling system. As described herein, the capability intent actions are the result of an AI productivity tool and/or AI productivity tool-enablable software application receiving user-query input from a user in an attempt to invoke responsive capability intent actions such as hardware component adjustments, software services, or other responses.

In an embodiment, the hardware processor executes computer-readable program code instructions of the intent dependency determination software application to identify capability dependencies of each of a plurality of AI productivity tool-enablable software applications and AI productivity tool modules executable at the information handling system. These capability dependencies may include any capability provided by any of the AI productivity tool-enablable software applications and AI productivity tool modules that may be affected by the capability intent action policies that had been created by the ITDM and transmitted to the individual information handling systems within the enterprise.

In an embodiment, the hardware processor may execute computer-readable program code instructions of a policy control managing subagent to transmit the one or more received capability intent action policies to the AI productivity tool-enablable software applications and AI productivity tool modules for applications of the capability intent action policies to manage impacts of the capability intent action policies at the information handling system. In an embodiment, a hardware processor may further execute computer-readable program code instructions of an intent dependency determination software application to identify actions that are forbidden based on the capability intent action policies as well as the various capabilities that have associated actions that may be performed via execution of one or more AI productivity tool-enablable software applications. Once these various capabilities have been identified, the matched capabilities with their associated AI productivity tool-enablable software applications and the capability intent action policies may be stored together for later use in identification of a forbidden intent action. In an embodiment, the hardware processor may further execute computer-readable program code instructions of the intent identification software application to invoke a machine learning (ML) model to generate vectorized intent action policy values for each of the received capability intent action policies, generate a vectorized capability intent value of each of the capabilities associated with each of the AI productivity tool-enablable software applications and AI productivity tool modules, and match the vectorized intent action policy values and vectorized capability intent value to map each of the capability intent action policies with a capability associated with each of the AI productivity tool-enablable software applications and AI productivity tool modules to identify capability dependencies of each of a plurality of AI productivity tool-enablable software applications and AI productivity tool modules executable at the information handling system.

The capability intent action policies may include a myriad of policies that can increase the system performance of each of the information handling systems, adapt to thermal and acoustic characteristics of each of the information handling systems, conduct resource management within each of the information handling systems, and provide adequate or required levels of security at each of the information handling systems. For example, the capability intent action policies may include a hardware processor intent action policy that describes allowed and disallowed processors that may be used by the AI productivity tool-enablable software applications and AI productivity tool modules executing one or more ML models to provide responsive capability intent actions to a user's input query. Additionally, the capability intent actions may include a capability-limiting intent action policy that describes capabilities available from the AI productivity tool-enablable software applications and AI productivity tool modules that are to be allowed or disallowed to be implemented. Still further, the capability intent actions may include a provider-limiting intent action policy that describes if and when the information handling system may transmit and receive data over a wired or wireless connection to a remote server executing the computer-readable program code instructions of the AI productivity tool-enablable software applications, AI productivity tool modules data, or other remote resources on behalf of the information handling system. Even further, the capability intent actions may include an updating intent actions policy that describes if and when to request updates to the capability intent action policies and how to map the capability intent action to the capabilities associated with each of the AI productivity tool-enablable software applications and AI productivity tool modules.

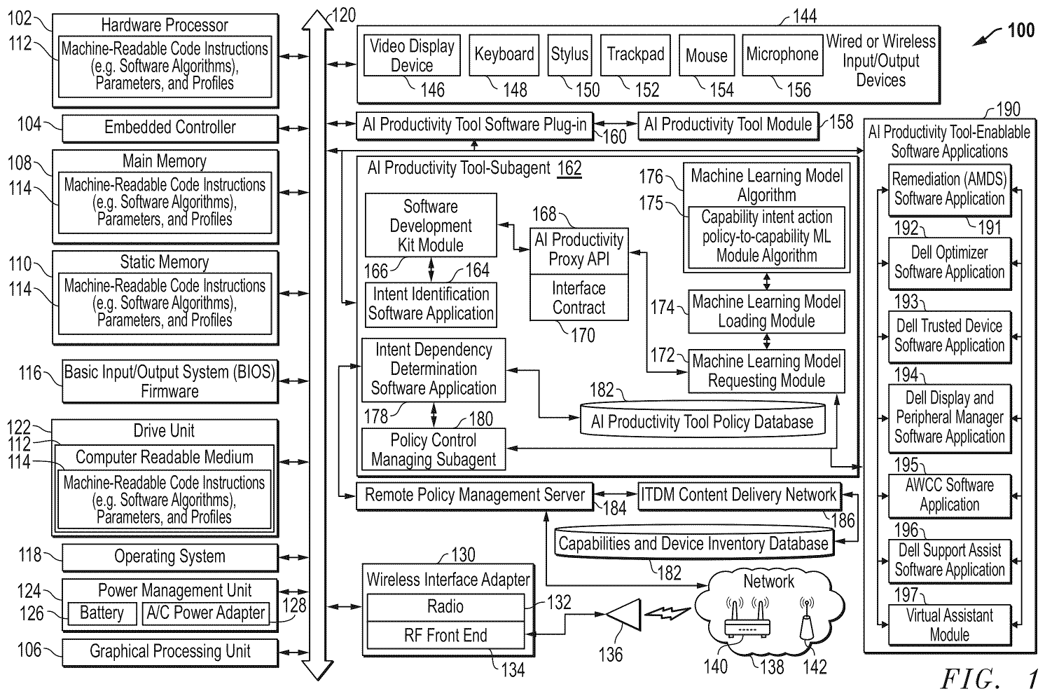

Turning now to the figures, FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 140, a base station transceiver 142, a wireless telephone, a control system, a camera, a scanner, a printer, a personal trusted device, a web appliance, or any other suitable machine capable of executing a set of instructions (sequential or otherwise) that specify capability intent actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 108, (volatile (e.g., random-access memory, etc.), or static memory 110, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, a neural processing unit (NPU), an accelerated processing unit (APU), other types of hardware processing devices, or any combination thereof. It is appreciated that the information handling system 100 may include any number of hardware processing devices described herein. Computer readable code instructions stored in main memory 108 (e.g., RAM) may be “hot” or quickly accessible by hardware processing resources using that main memory 108. Computer-readable program code instructions stored in static memory 110, main memory 108, or drive unit 122 may be “cold” and latency may be involved in invoking such computer-readable program code instructions to main memory 108 according to embodiments herein. Additional components of the information handling system 100 may include one or more storage devices such as static memory 110 or drive unit 122. The information handling system 100 may include or interface with one or more communications ports for communicating with external devices, as well as various input and output (I/O) devices 144, such as a mouse 154, a trackpad 152, a stylus 150, a keyboard 148, a video/graphics display device 146, a microphone 192, or any combination thereof. Portions of an information handling system 100 may themselves be considered information handling systems 100.

Information handling system 100 may include devices or modules that embody one or more of the devices or execute instructions for one or more systems and modules. The information handling system 100 may execute instructions (e.g., software algorithms), parameters, and profiles 114 that may operate on servers or systems, remote data centers, or on-box in individual client information handling systems according to various embodiments herein. In some embodiments, it is understood any or all portions of instructions (e.g., software algorithms), parameters, and profiles 114 may operate on a plurality of information handling systems 100.

The information handling system 100 may include the hardware processor 102 such as a central processing unit (CPU) or other hardware processing resources. Any of the hardware processing resources may operate to execute code that is either firmware or software code. Moreover, the information handling system 100 may include memory such as main memory 108, static memory 110, and disk drive unit 122 (volatile (e.g., random-access memory, etc.), nonvolatile memory (read-only memory, flash memory etc.) or any combination thereof or other memory with computer readable medium 112 storing instructions (e.g., software algorithms), parameters, and profiles 114 executable by the hardware processor 102 (e.g., central processing unit), NPU, APU, EC 104, GPU 106, or any other hardware processing device. The information handling system 100 may also include one or more buses 120 operable to transmit communications between the various hardware components such as any combination of various I/O devices 144 as well as between hardware processors 102, an EC 104, the operating system (OS) 118, the basic input/output system (BIOS) 116, the wireless interface adapter 130, or a radio module, among other components described herein. In an embodiment, the hardware processor 102, EC 104, GPU 106, NPU, APU, and/or others may execute one or more bus drivers in order to transmit this data between the information handling system 100 and the input/output devices 144 described herein. In an embodiment, the information handling system 100 may be in wired or wireless communication with the I/O devices 144 such a keyboard 148, a mouse 154, video display device 146, stylus 150, trackpad 152, microphone 192, among other peripheral devices.

As described herein, the information handling system 100 further includes a video/graphics display device 146. The video/graphics display device 146 in an embodiment may function as a liquid crystal display (LCD), an organic light emitting diode (OLED), a flat panel display, or a solid-state display. It is appreciated that the video/graphics display device 146 may be wired or wireless and may be an external video/graphics display device 146 that allows a user to increase the desktop area by extending the desktop in an embodiment. Additionally, as described herein, the information handling system 100 may include or be operatively coupled to a cursor control device (e.g., a trackpad 152, or gesture or touch screen input), a stylus 150, and/or a keyboard 148, among others that allows the user to interface with the information handling system 100 via the video/graphics display device 146. Information handling system 100 may also be operatively coupled to a wired or wireless input/output device 144 or other hardware devices that may include a hardware processing device such as a hardware processor, microcontroller, or other hardware processing resource. Various drivers and hardware control device electronics may be operatively coupled to operate the I/O devices 144 according to the embodiments described herein. The present specification contemplates that the I/O devices 144 may be wired or wireless.

A network interface device of the information handling system 100 may be wired or wireless such as shown with wireless interface adapter 130 that can provide wireless connectivity among devices such as with Bluetooth® or to a network 138, e.g., a wide area network (WAN), a local area network (LAN), wireless local area network (WLAN), a wireless personal area network (WPAN), a wireless wide area network (WWAN), or other network. In embodiments described herein, the wireless interface device 130 with its radio 132, RF front end 134 and antenna 136 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth®, BLE, proprietary RF protocol, or other WPAN or WLAN protocols and plural such protocols may be used for communication with and among any wireless peripheral device to be paired or paired with the information handling system 100 or other information handling systems.

In other embodiments, a WAN, WWAN, LAN, and WLAN may each include an AP 140 or base station 142 used to operatively couple the information handling system 100 to a network 138 via a wireless interface adapter 130. In a specific embodiment, the network 138 may include macro-cellular connections via one or more base stations 142 or a wireless AP 140 (e.g., Wi-Fi), or such as through licensed or unlicensed WWAN small cell base stations 142. Connectivity may be via wired or wireless connection. For example, wireless network wireless APs 140 or base stations 142 may be operatively connected to the information handling system 100. Wireless interface adapter 130 may include one or more RF (RF) subsystems (e.g., radio 132) with transmitter/receiver circuitry, modem circuitry, one or more antenna RF (RF) front end circuits 134, one or more wireless controller circuits, amplifiers, antennas 136 and other circuitry of the radio 132 such as one or more antenna ports used for wireless communications via multiple radio access technologies (RATs). The radio 132 may communicate with one or more wireless technology protocols.

In an embodiment, the wireless interface adapter 130 may operate in accordance with any wireless data communication standards. To communicate with a wireless local area network, standards including IEEE 802.11 WLAN standards (e.g., IEEE 802.11ax-2021 (Wi-Fi 6E, 6 GHZ)), IEEE 802.15 WPAN standards, WWAN such as 3GPP or 3GPP2, Bluetooth® standards, proprietary RF protocol, or similar wireless standards may be used. Wireless interface adapter 130 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 130 can represent an add-in card, wireless network interface module that is integrated with a main board of the information handling system 100 or integrated with another wireless network interface capability, or any combination thereof.

In some embodiments, a hardware processing resource executes computer-readable program code instructions of software or firmware to implement one or more of some systems and methods described herein, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware devices with related control and data signals that may be communicated between and through the modules, or as portions of an application-specific integrated circuit. Accordingly, the present system encompasses a hardware processing resource executing computer-readable program code instructions of software or firmware as well as hardware implementations or any combination.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable program code instructions, parameters, and profiles 114 or receives and executes computer-readable program code instructions, parameters, and profiles 114 responsive to a propagated signal, so that a hardware device connected to a network 138 may communicate voice, video, or data over the network 138. Further, the computer-readable program code instructions, parameters, and profiles 114 may be transmitted or received over the network 138 via the network interface device or wireless interface adapter 130.

The information handling system 100 may include a set of computer-readable program code instructions, parameters, and profiles 114 that may be executed to cause the computer system to perform any one or more of the methods or computer-based functions disclosed herein. For example, computer-readable program code instructions, parameters, and profiles 114 may be executed by a hardware processor 102, GPU 106, EC 104 or any other hardware processing resource and may include software agents, or other aspects or components used to execute the methods and systems described herein. Various software modules comprising application computer-readable program code instructions, parameters, and profiles 114 may be coordinated by an OS 118, and/or via an application programming interface (API). An example OS 118 may include Windows®, Android®, and other OS types. Example APIs may include Win 32, Core Java API, or Android APIs.

In an embodiment, the information handling system 100 may include a disk drive unit 122. The disk drive unit 122 and may include machine-readable program code instructions, parameters, and profiles 114 in which one or more sets of machine-readable program code instructions, parameters, and profiles 114 such as firmware or software can be embedded to be executed by the hardware processor 102 (e.g., CPU) or other hardware processing devices such as a GPU 106, an EC 104, an NPU, an APU, or other hardware processing resource device to perform the processes described herein. Similarly, main memory 108 and static memory 110 may also contain a computer-readable medium for storage of one or more sets of machine-readable program code instructions, parameters, or profiles 114 described herein. The disk drive unit 122 or static memory 110 also contain space for data storage. Further, the machine-readable program code instructions, parameters, and profiles 114 may embody one or more of the methods as described herein. In a particular embodiment, the machine-readable program code instructions, parameters, and profiles 114 may reside completely, or at least partially, within the main memory 108, the static memory 110, and/or within the disk drive 122 during execution by the hardware processor 102, EC 104, or GPU 106 of information handling system 100.

Main memory 108 or other memory of the embodiments described herein may contain computer-readable medium (not shown), such as RAM in an example embodiment. An example of main memory 108 includes random access memory (RAM) such as static RAM (SRAM), dynamic RAM (DRAM), non-volatile RAM (NV-RAM), or the like, read only memory (ROM), another type of memory, or a combination thereof. Static memory 110 may contain computer-readable medium (not shown), such as NOR or NAND flash memory in some example embodiments. The applications and associated APIs, for example, may be stored in static memory 110 or on the disk drive unit 122 that may include access to a machine-readable code instructions, parameters, and profiles 114 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 124 (a.k.a. a power supply unit (PSU)). The PMU 124 may include a hardware controller and executable machine-readable code instructions to manage the power provided to the components of the information handling system 100 such as the hardware processor 102 and other hardware components described herein. The PMU 124 may control power to one or more components including the one or more drive units 122, the hardware processor 102 (e.g., CPU), the EC 104, the GPU 106, a video/graphic display device 146, or other wired I/O devices 144 such as the mouse 154, the stylus 150, the keyboard 148, and the trackpad 152 and other components that may require power when a power button has been actuated by a user. In an embodiment, the PMU 124 may monitor power levels and be electrically coupled to the information handling system 100 to provide this power. The PMU 124 may be coupled to the bus 120 to provide or receive data or machine-readable code instructions. The PMU 124 may regulate power from a power source such as the battery 126 or AC power adapter 128. In an embodiment, the battery 126 may be charged via the AC power adapter 128 and provide power to the components of the information handling system 100, via wired connections as applicable, or when AC power from the AC power adapter 128 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 110 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described in embodiments herein, the information handling system 100 includes an AI productivity tool module 158 and an AI productivity tool subagent 162 to select among a plurality of machine learning (ML) model algorithms 176 for use with execution of a plurality of AI productivity tool-enablable software applications 190 according to another embodiment of the present disclosure. As described herein, the AI productivity tool module 158 and AI productivity tool subagent 162 may be executed by a hardware processor 102 on the information handling system 100 thereby allowing the methods described herein to be carried out on-the-box such that a wired or wireless network connection to a network is not necessary for operation of the method. In another embodiment, some modules, databases, and/or processing resources may be maintained on a remote server such that a wired or wireless network connection can be made with these remote servers and the method may be implemented as described herein.

The AI productivity tool module 156 may include any artificial intelligence-based productivity tool to assist in interfacing with and execution of one or more AI productivity tool-enablable software applications 190 or inputs and responses from a user of an information handling system 100. The AI productivity tool module 158 may be loaded on-the-box by a manufacturer in software and may include chatbot features, virtual assistant features, and other artificial intelligence features that allow a user to provide input to the information handling system 100 and, with generative artificial intelligence processing of a user input query, execute one or more capabilities that include hardware operations, functions, software services, or responses using one or more AI productivity tool-enablable software applications 190. Examples of some AI productivity tool modules 158 may include Cortana® by Microsoft®, Copilot® by Microsoft®, Siri® by Apple® Inc., Gemini® by Google AIR, ChatGPT® by OpenAI®, and Amazon Alexa® by Amazon®, among others. It is appreciated that the information handling system 100 may include any proprietary AI productivity tool module 158 installed by an information handling system 100 manufacturer and used to interface with the information handling system 100 and the operations thereon. In various embodiments, the hardware processor 102 or other alternative hardware processing resources of the information handling system 100 may execute computer-readable program code instructions of the AI productivity tool module 158 with its AI productivity tool plug-in 160 and monitor for user input for a user query at a microphone 156, keyboard 148, or other input device for the AI productivity tool module 158 to engage in Capability intent actions pursuant to the user query input.

The AI productivity tool module 158, executing on the hardware processor 102 or other hardware processing resource (e.g., EC 104, GPU 106, APU, or NPU), may interface with other hardware components and with the AI productivity tool-enablable software applications 190 and one or more ML module algorithms 176 the information handling system 100 via an AI productivity tool plug-in 160. The AI productivity tool plug-in 160 may be any software or firmware that allows the AI productivity tool module 158 to perform those actions at the information handling system 100 based on user-query input (e.g., typed, spoken words, images, etc.) provided from the user. The AI productivity tool plug-in 160 may be used by the AI productivity tool module 158 and AI productivity tool subagent 162 to interface with any number of AI productivity tool-enablable software applications 190 executing or executable on the information handling system 100 according to embodiments herein.

The information handling system 100 also includes the AI productivity tool subagent 162 of the AI productivity tool module 158. The AI productivity tool subagent 162 may be any software and/or firmware executable by the hardware processor 102 of the information handling system 100 to interface one or more of the plurality of the AI productivity tool-enablable software applications 190 (such as a remediation (AMDS) software application 191, Dell® Optimizer® software application 192, Dell® Trusted Device® software application 193, Dell® Display and Peripheral Manager® software application 194, AWCC software application 195, Dell® Support Assist® software application 196, virtual assistant module 197) to provide AI enabled capabilities within those AI productivity tool-enablable software applications (e.g., 190, 191, 192, 193, 194, 195, 196, 197) for responsive hardware, firmware, or software operations, functions, software services, or responses to user input queries.

In an embodiment, the computer-readable program code instructions of the software applications (e.g., AI productivity tool-enablable software applications 190) and modules described herein (e.g., 190, 191, 192, 193, 194, 195, 196, 197) may operate wholly “on-box” within the information handling system 100 or be sub-agents on-box for interfacing with remote software systems executing at remote server locations such as the remote policy management server 184 described herein. In an embodiment, the AI productivity tool subagent 162 may be used to direct the execution of various modules in support of the AI productivity tool-enablable software applications 190 described herein. Additionally, the AI productivity tool subagent 162 may be provided with access to the BIOS and OS of the information handling system 100 to conduct the capability intent actions pursuant to the user's query input provided via the AI productivity tool module 158 or with an interface of one of the AI productivity tool-enablable software applications 190.

In an embodiment, the hardware processor 102 or other hardware processing resource (e.g., EC 104, GPU 106, CPU, APU, or NPU) executing computer-readable program code instructions of the AI productivity tool subagent 162 that may include an intent identification software application 164. The intent identification software application 164 may engage with a machine learning model requesting module 172 to have one or more machine learning (ML) model algorithms 176 loaded and executed on the hardware processor in order to, initially, determine the query intent value to correlate with a capability intent action to be conducted responsive to the received user-query inputs. The execution of the computer-readable program code instructions of the intent identification software application 164 may call a software development kit (SDK) module 166. The SDK module 166 may include any computer-readable program code instructions that is executed by the hardware processor 102 or other hardware processing resource to request that a ML model algorithm 176 be invoked to support an identification of, in an embodiment, a capability intent action based on received user-query inputs from a user. For example, the ML model algorithm 176 may include a query input-to-intent ML model algorithm that receives the user-query input, and with an embedding algorithm generates a vectorized query intent value for the user-query input for later correlation with a capability intent value.

The ML model algorithm 176 may also include a query intent-to-capability matching ML model algorithm that receives the vectorized query intent value as input and matches the vectorized query intent value to a vectorized capability intent value associated with the AI productivity tool-enablable software application 190 via a similarity correlation algorithm to identify a capability that can serve as the capability intent action responsive to a user-query input. It is appreciated that the selected ML model algorithms 176 may satisfy an interface contract 170 requested by the intent identification software application 164 such that the query intent value from the user-query inputs may be interpreted and an available capability associated with one of the plurality of AI productivity tool-enablable software applications 190 as the capability intent action can be matched to the user's query input. The interface contract 170 described herein defines the requirements that selected ML model algorithms 176 are to have in order to be able receive a specific type of input from the intent identification software application 164 or any AI productivity tool-enablable software application 190 and to provide a specific type of output to the intent identification software application 164 and/or AI productivity tool-enablable software applications 190. In an embodiment, the interface contract 170 is generated by an AI productivity proxy API 168 invoked by the SDK module 166 in order to identify the specific ML model algorithm 176 that provides the appropriate output to the intent identification software application 164. The execution of the computer-readable program code of the intent identification software application 164 allows a user to interface with the AI productivity tool module 158 (e.g., via text, audio, images, etc.) and have a responsive action, such as a hardware operation or adjustment, software service, or other response from the information handling system 100 that satisfies the user's query input.

It is appreciated, however, that not all user's query inputs can or should be executed at the information handling system 100. For example, an ITDM may wish to restrict one or more users of an information handling system 100 within an enterprise of information handling systems from engaging in operations that may adversely affect the operation of the information handling system. For example, an ITDM may want to prevent one or more end users of any of the information handling systems within the enterprise from providing data to or receive data from a remote server. This may be due to security issues that may arise when transmitting secure data to or from the remote server. In another example embodiment, the ITDM may wish to prevent a user from altering audio settings on a communally-located information handling system such as an information handling system within a common workspace or conference room so that no cross-platform audio sensitivity issues arise. It is appreciated that the ITDM may wish to control the specific operations on the information handling system 100 such as which capabilities associated with specific AI productivity tool-enablable software applications 190 can be invoked by operation of the intent identification software application 164 and AI productivity tool subagent 162 via interface of a user-query input to the AI productivity tool modules 158 in embodiments as described herein.

In order to control the specific operation of any given information handling system 100 within an enterprise that operates to be responsive to user query inputs, the ITDM may generate any number of capability intent action policies via the ITDM content delivery network 186. These capability intent action policies may be transmitted down from a remote policy management server 184 to one or more managed information handling systems 100 to effectuate those capability intent action policies as directed by the ITDM or other policy generating entity. In an example embodiment, an ITDM may access an ITDM content delivery network 186 in order to generate these capability intent action policies for transmission down to each of the information handling systems 100. Thus, in an embodiment, an ITDM may be presented with a graphical user interface (GUI) on the remote policy management server 184 that is executing the computer-readable program code of the ITDM content delivery network 186 to generate these capability intent action policies. In an embodiment, the ITDM content delivery network 186 may be provided with specific details of each of the information handling systems 100 within the enterprise by accessing a capabilities and device inventory database 188 and may further classify various information handling systems 100 into sub-groups for security operating capabilities or other factors. The capabilities and device inventory database 188 may provide categorizing data about each of the information handling systems 100 within the enterprise, the AI productivity tool-enablable software applications 190 and ML mode algorithms 176 executing or executable on those information handling systems 100, as well as other features of the hardware, software, and firmware of each information handling system 100 within the enterprise in order to be made aware of which capability intent action policies are to be distributed down to which information handling system 100 within the enterprise.

After developing these capability intent action policies, the capability intent action policies may be passed down to the information handling system 100 executing computer-readable program code instructions of an intent dependency determination software application 178. The intent dependency determination software application 178 may receive the capability intent action policies and, in an embodiment, begin to identify capability dependencies of each of the plurality of AI productivity tool-enablable software applications 190 and AI productivity tool modules 158 executable at the information handling system 100 that are affected by the received capability intent action policies. For example, the ITDM may create a capability intent action policy that enables or disables capabilities associated with one or more of the AI productivity tool-enablable software applications 190 so that those AI productivity tool-enablable software applications 190 are prevented from executing a service, hardware or software operation, response, or other function in response to a user-query input. A specific example, the ITDM may have created a capability intent action policy that prevents the user from requesting that certain security changes be made to the operations of the information handling system 100. This capability intent action policy may be transmitted to the intent dependency determination software application 178 which then identifies capabilities associated with any AI productivity tool-enablable software applications 190 (e.g., Dell® Trusted Device® software application 193, Dell® Display and Peripheral Manager® software application 194, Dell® Support Assist® software application 196) that allow for the user to change security settings.

The identification of capability dependencies associated with any of the AI productivity tool-enablable software applications 190 that could be affected by the capability intent action policies are then passed onto a policy control managing subagent 180. The execution of the computer-readable program code instructions of the policy control managing subagent 180 may transmit the capability intent action policies to the AI productivity tool-enablable software applications 190 and AI productivity tool module 158 for application of the capability intent action policies in order to manage impacts of the capability intent action policies at the information handling system 100.

In an embodiment, the execution of the computer-readable program code instructions of the intent dependency determination software application 178 may cause each of the capability intent action policies to be stored on an AI productivity tool policy database 182 at the information handling system 100. In an embodiment, these capability intent action policies may be associated with an AI productivity tool module or AI productivity tool-enablable software application within the AI productivity tool policy database 182 at the information handling system 100 that may be affected by the individual capability intent action policies received. The AI productivity tool policy database maintains the capability intent action policies as well as mappings of the capability intent action policies and capability dependencies relative to their respective AI productivity tool-enablable software applications or AI productivity tool modules at the information handling system. In this way, when a capability intent action is requested, the AI productivity tool policy database may determine from the mappings of the capability intent action policies and capability dependencies relative to their respective AI productivity tool-enablable software applications or AI productivity tool modules at the information handling system when to apply limitations, adjustments, or expansion of the capability intent action pursuant to the corresponding, received capability intent action policy.

In an embodiment, the hardware processor 102 or other processing resource (e.g., EC 104, GPU 106, APU, NPU, etc.) may further execute computer-readable program code instructions of the intent dependency determination software application 178 to identify actions that are forbidden based on the capability intent action policies as well as the various capabilities that have associated actions that may be performed via execution of one or more AI productivity tool-enablable software applications. For example, when the information handling system 100 receives a capability intent action policy, the execution of the computer readable program code instructions of the intent dependency determination software application 178 may cause the intent dependency determination software application 178 to access the capabilities associated with each of the AI productivity tool-enablable software applications 190 (e.g., 191, 192, 193, 194, 195, 196, 197) and determine whether a corresponding action that can be conducted is in violation of the capability intent action policy received or any of the other capability intent action policies received at the information handling system 100. Once these various capabilities have been identified, the matched capabilities with their associated AI productivity tool-enablable software applications and the capability intent action policies may be stored in the AI productivity tool policy database 182 together for later use in identification of a forbidden intent action. Thus, when a user provides user-query input at the AI productivity tool module 158 that requests an action that is forbidden based on the capability intent action policies, the intent identification software application 164 may reference this data stored on the AI productivity tool policy database 182 to, prior to the action being taken, determine if that action is forbidden. It is appreciated that not all capabilities associated with any given AI productivity tool-enablable software application 190 may be prohibited by a single capability intent action policy. It is also appreciated that a single capability intent action policy may not applicable to a single capability associated with one or more AI productivity tool-enablable software applications 190.

It is appreciated that as the computer-readable program code instructions of the intent dependency determination software application 178 is executed by the hardware processor 102 or other processing resource (e.g., EC 104, GPU 106, APU, NPU, etc.), the intent dependency determination software application 178 may interface with the machine learning model requesting module 172 in order to invoke one or more ML model algorithms 176 in order to identify the capability dependencies of the capability intent action policies relative to the individual AI productivity tool-enablable software applications 190. For example, the ML model algorithm 176 invoked on behalf of the intent dependency determination software application 178 via the machine learning model requesting module 172 and loaded by the machine learning model loading module 174 may include a capability intent action policy-to-capability ML model algorithm 175. In this embodiment, execution of the computer-readable program code instructions of the intent action policy-to-capability ML model algorithm 175 receives the capability intent action policy inputs and correlates the capability intent action policy received with a capability natural language description or capability intent value for one or more capabilities. This identifies a capability intent action that is associated with one or more AI productivity tool-enablable software applications 190, and provides, as output to the intent dependency determination software application 178 an indication of the capability dependencies of each of a plurality of AI productivity tool-enablable software applications and AI productivity tool modules that are affected by the capability intent action policies. After identifying these capability dependencies, the intent dependency determination software application 178 may designate the capability intent actions affected and pass these capability dependencies on to the policy control managing subagent 180 which transmits the capability intent action policies to the AI productivity tool-enablable software applications 190 and AI productivity tool modules 158 and AI productivity tool subagent 162 for application of the capability intent action policies to manage impacts of the capability intent action policies during execution at the information handling system. This causes the capability intent action policies to be applied to the capability intent actions of the AI productivity tool-enablable software application 190 for operations of the information handling system 100 such that those capability intent action policies created by the ITDM to control the impacts on the hardware, software, and firmware resources of the information handling system 100. This allows the ITDM to prevent adverse impacts due to the user of the information handling system 100 engaging with the AI productivity tool module 158 and/or AI productivity tool subagent 162.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

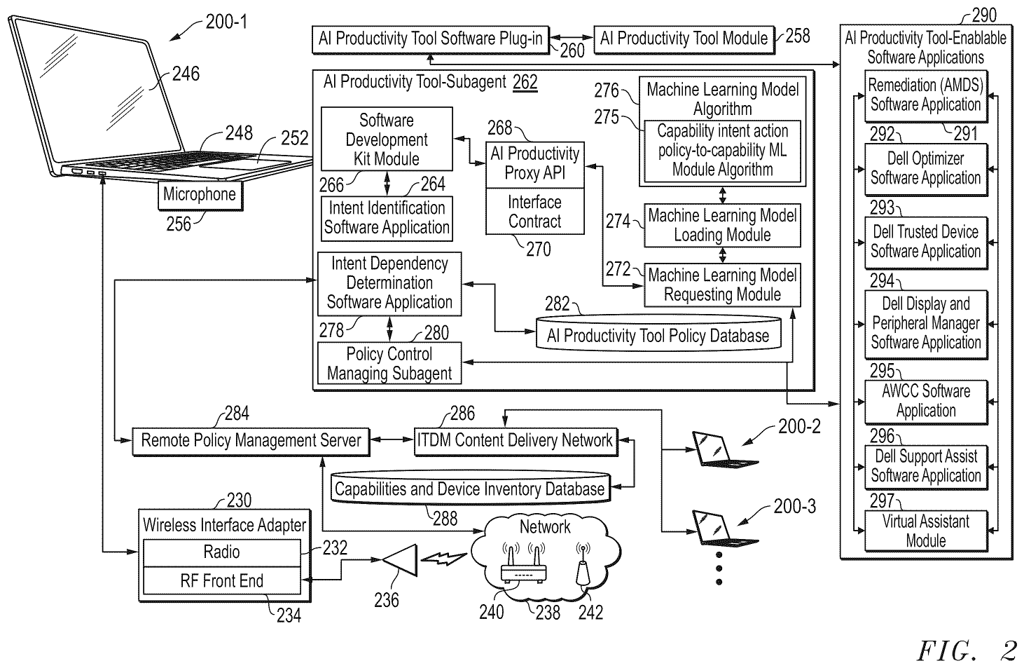

FIG. 2 is a graphic and block diagram illustrating an information handling system 200-1 that includes an AI productivity tool module 258 to select among a plurality of AI productivity tool-enablable software applications 290 for software services, hardware operations, or other responses of those AI productivity tool-enablable software applications 290 as allowed under one or more capability intent action policies according to an embodiment of the present disclosure. As described herein, the information handling system 200-1 may be one among a plurality of managed information handling systems 200-1, 200-2, 200-3 that may be managed by an ITDM by propagating one or more capability intent action policies to one or more of these information handling systems 200-1, 200-2, 200-3. The ITDM may generate these capability intent action policies via the ITDM content delivery network 286 as described herein.

In an embodiment, the ITDM may be presented with a GUI on a video display device associated with a remote policy management server 284. The remote policy management server 284 and ITDM content delivery network 286 may be remote from an information handling system being operated by the ITDM in an embodiment. In these embodiments, the ITDM may be presented with a GUI that presents a listing of each information handling systems 200-1, 200-2, 200-3 within an enterprise or that the ITDM is responsible for establishing and providing the capability intent action policies to. In order to provide this data related to each of the information handling systems 200-1, 200-2, 200-3, the GUI may access a capabilities and device inventory database 288. The capabilities and device inventory database 288 may include a listing of each information handling systems 200-1, 200-2, 200-3, the hardware present on the information handling systems 200-1, 200-2, 200-3, the executable software on the information handling systems 200-1, 200-2, 200-3, firmware on the information handling systems 200-1, 200-2, 200-3, and any capabilities associated with any of the AI productivity tool-enablable software applications 290 (e.g., 291, 292, 293, 294, 295, 296, 297), the AI productivity tool module 258, the AI productivity tool subagent 262, and any other AI productivity tool plugins associated with executable software on the information handling systems 200-1, 200-2, 200-3 such as AI productivity tool plugins associated with word processing software, spreadsheet creation software, CAD software, image editing software, and the like.

In an embodiment, the ITDM may cause computer-readable program code instructions of the ITDM content delivery network 286 to generate these capability intent action policies for transmission down to each of the information handling systems 200-1, 200-2, 200-3. The capability intent action policies, when generated, may be pushed down to each information handling systems 200-1, 200-2, 200-3 either via a wired or wireless connection established between the information handling systems 200-1, 200-2, 200-3 and the remote policy management server 284. In an embodiment, these capability intent action policies may be transmitted to each of the information handling systems 200-1, 200-2, 200-3 using XML-based administrative template file (e.g., .admx files) format. It is appreciated that other types of file formats may be used such as group policy object (GPO) file types and the present specification contemplates these other types of file formats used to transmit the capability intent action policies to each of the information handling systems 200-1, 200-2, 200-3.

During operation of each of the information handling systems 200-1, 200-2, 200-3, a user may engage in AI-supported capability intent actions that leverage AI technologies described herein in order to execute a service, hardware or software operation, response, or other function in response to a user-query input. Again, to facilitate this, the information handling system 200-1 (and each of the information handling systems 200-1, 200-2, 200-3) may include an AI productivity tool module 258 and an AI productivity tool subagent 262 to select among a plurality of ML model algorithms 276 to process user-query inputs and for use with execution of a plurality of AI productivity tool-enablable software applications 290 according to an embodiment of the present disclosure. As described herein, the AI productivity tool module 258 and AI productivity tool subagent 262 may be executed by a hardware processor 202 on the information handling system 200 thereby allowing the methods described herein to be carried out on-the-box such that a wired or wireless network connection to a network is not necessary for operation of the method. In another embodiment, some modules, databases, and/or processing resources may be maintained on a remote server such that a wired or wireless network connection can be made with these remote servers and the method may be implemented as described herein.

The AI productivity tool module 256 may include any artificial intelligence-based productivity tool to assist in interfacing with and execution of one or more AI productivity tool-enablable software applications 290 for inputs and responses from a user of an information handling system 200. The AI productivity tool module 258 may be loaded on-the-box by a manufacturer in software and may include chatbot features, virtual assistant features, and other artificial intelligence features that allow a user to provide input to the information handling system 200. The AI productivity tool modules 258 with generative artificial intelligence, process a user input query and execute one or more capabilities that include hardware and software operations, functions, software services, or responses using one or more AI productivity tool-enablable software applications 290. Examples of some AI productivity tool modules 258 may include Cortana® by Microsoft®, Copilot® by Microsoft®, Siri® by Apple® Inc., Gemini® by Google AIR, ChatGPT® by OpenAI®, and Amazon Alexa® by Amazon®, among others. It is appreciated that the information handling system 200 may include any proprietary AI productivity tool module 258 installed by an information handling system 200 manufacturer and used to interface with the information handling system 200 and the operations thereon. In various embodiments, the hardware processor 202 or other alternative hardware processing resources of the information handling system 200 may execute computer-readable program code instructions of the AI productivity tool module 258 with its AI productivity tool plug-in 260 and monitor for user input for a user query at a microphone 256, keyboard 248, or other input device for the AI productivity tool module 258 to engage in Capability intent actions pursuant to the user-query input.

The AI productivity tool module 258, executing on the hardware processor 202 or other hardware processing resource (e.g., EC 204, GPU 206, APU, or NPU), may interface with other hardware components and with the AI productivity tool-enablable software applications 290 and one or more ML module algorithms 276 on the information handling system 200 via an AI productivity tool plug-in 260. The AI productivity tool plug-in 260 may be any software or firmware that allows the AI productivity tool module 258 to perform those actions at the information handling system 200 based on user-query input (e.g., typed, spoken words, images, etc.) provided from the user. The AI productivity tool plug-in 260 may be used by the AI productivity tool module 258 and AI productivity tool subagent 262 to interface with any number of AI productivity tool-enablable software applications 290 executing or executable on the information handling system 200 according to embodiments herein.

The information handling system 200 also includes the AI productivity tool subagent 262 of the AI productivity tool module 258. The AI productivity tool subagent 262 may be any software and/or firmware executable by the hardware processor 202 of the information handling system 200 to interface one or more of the plurality of the AI productivity tool-enablable software applications 290 (such as a remediation (AMDS) software application 291, Dell® Optimizer® software application 292, Dell® Trusted Device® software application 293, Dell® Display and Peripheral Manager® software application 294, AWCC software application 295, Dell® Support Assist® software application 296, virtual assistant module 297) to provide AI enabled capabilities within those AI productivity tool-enablable software applications (e.g., 290, 291, 292, 293, 294, 295, 296, 297) for responsive hardware or software operations, functions, software services, or responses to user input queries. In an embodiment, the computer-readable program code instructions of the software applications (e.g., AI productivity tool-enablable software applications 290) and modules described herein (e.g., 290, 291, 292, 293, 294, 295, 296, 297) may operate wholly “on-box” within the information handling system 200 or be sub-agents on-box for interfacing with remote software systems executing at remote server locations such as the remote policy management server 284 described herein. In an embodiment, the AI productivity tool subagent 262 may be used to direct the execution of various modules in support of the AI productivity tool-enablable software applications 290 described herein. Additionally, the AI productivity tool subagent 262 may be provided with access to the BIOS and OS of the information handling system 200 to conduct the capability intent actions pursuant to the user's query input provided via the AI productivity tool module 258 or with an interface of one of the AI productivity tool-enablable software applications 290.

In an embodiment, the hardware processor 202 or other hardware processing resource (e.g., EC 204, GPU 206, CPU, APU, or NPU) executing computer-readable program code instructions of the AI productivity tool subagent 262 that may include an intent identification software application 264. The intent identification software application 264 may engage with a machine learning model requesting module 272 to have one or more machine learning (ML) model algorithms 276 loaded and executed on the hardware processor in order to, initially, determine the query intent value to correlate with a capability intent action to be conducted responsive to the received user-query inputs. The execution of the computer-readable program code instructions of the intent identification software application 264 may call a software development kit (SDK) module 266. The SDK module 266 may include any computer-readable program code instructions that is executed by the hardware processor 202 or other hardware processing resource to request that a ML model algorithm 276 be invoked to support an identification of, in an embodiment, a capability intent action based on received user-query inputs from a user. For example, the ML model algorithm 276 may include a query input-to-intent ML model algorithm that receives the user-query input, and with an embedding algorithm generates a vectorized query intent value for the user-query input.

The ML model algorithm 276 may also include a query intent-to-capability matching ML model algorithm that receives the assigned vectorized query intent value as input and matches the vectorized query intent value to a vectorized capability intent value associated with the AI productivity tool-enablable software application 290 that can serve as the capability intent action responsive to a user-query input. It is appreciated that the selected ML model algorithms 276 may satisfy an interface contract 270 requested by the intent identification software application 264 such that the query intent value from the user-query inputs may be interpreted and the capability intent action for an available capability associated with one of the plurality of AI productivity tool-enablable software applications 290 can be matched to the user's query input. The interface contract 270 described herein defines the requirements that selected ML model algorithms 276 are to have in order to be able receive a specific type of input from the intent identification software application 264 or any AI productivity tool-enablable software application 290 and to provide a specific type of output to the intent identification software application 264 and/or AI productivity tool-enablable software applications 290. In an embodiment, the interface contract 270 is generated by an AI productivity proxy API 268 invoked by the SDK module 266 in order to identify the specific ML model algorithm 276 that provides the appropriate output to the intent identification software application 264. The execution of the computer-readable program code of the intent identification software application 264 allows a user to interface with the AI productivity tool module 258 (e.g., via text, audio, images, etc.) and have a responsive action, such as a hardware operation, software service, or other response from the information handling system 200 that satisfies the user's query input.

It is appreciated, however, that not all user's query inputs can or should be executed at the information handling system 200. For example, an ITDM may wish to restrict one or more users of an information handling system 200 within an enterprise of information handling systems from engaging in operations that may adversely affect the operation of the information handling system. For example, an ITDM may want to prevent one or more end users of any of the information handling systems within the enterprise from providing data to or receive data from a remote server. This may be due to security issues that may arise when transmitting secure data to or from the remote server. In another example embodiment, the ITDM may wish to prevent a user from altering audio settings on a communally-located information handling system such as an information handling system within a common workspace or conference room so that no cross-platform audio sensitivity issues arise. It is appreciated that the ITDM may wish to control the specific operations on the information handling system 200 such as which capabilities associated with specific AI productivity tool-enablable software applications 290 can be invoked by operation of the intent identification software application 264 and AI productivity tool subagent 262 via interface of a user-query input to the AI productivity tool modules 258 in embodiments as described herein.

In order to control the specific operation of any given information handling system 200 within an enterprise responsive to user query inputs, the ITDM-generated capability intent action policies are implemented during any assessment of a user's query input. In an embodiment, the capability intent action policies may be established by an ITDM via the ITDM content delivery network 286 and may be passed down to the information handling system 200 executing computer-readable program code instructions of an intent dependency determination software application 278. The intent dependency determination software application 278 may receive the capability intent action policies and, in an embodiment, begin to identify capability dependencies of each of the plurality of AI productivity tool-enablable software applications 290 and AI productivity tool modules 258 executable at the information handling system 200 that are affected by the capability intent action policies. For example, the ITDM may create a capability intent action policy that enables or disables capabilities associated with one or more of the AI productivity tool-enablable software applications 290 so that those AI productivity tool-enablable software applications 290 are prevented from executing a service, hardware or software operation, response, or other function in response to a user-query input. A specific example, the ITDM may have created a capability intent action policy that prevents the user from requesting that certain security changes be made to the operations of the information handling system 200. This capability intent action policy may be transmitted to the intent dependency determination software application 278. The execution of the computer-readable program code instructions of the intent dependency determination software application 278 identifies capabilities associated with any AI productivity tool-enablable software applications 290 (e.g., Dell® Trusted Device® software application 293, Dell® Display and Peripheral Manager® software application 294, Dell® Support Assist® software application 296) that could otherwise allow for the user to change security settings.

In an embodiment, the hardware processor 202 or other hardware processing device (e.g., APU, NPU, EC, GPU) may execute computer-readable program code instructions of the intent identification software application to invoke one or more ML model algorithms that can be used to map the received capability intent action policies with one or more of the AI productivity tool-enablable software applications 290 and the AI productivity tool modules 258. In an embodiment, the execution of the intent dependency determination software application 278 also identifies the capability dependencies of the capability intent action policies to the AI productivity tool-enablable software applications 290 (e.g., 291, 292, 293, 294, 295, 296, 297) and AI productivity tool modules 258. This may be done by passing the received capability intent action policies through the machine learning model requesting module 272 and having an appropriate ML model algorithm 276 be loaded by the machine learning model loading module 274. For example, the ML model algorithm 276 invoked on behalf of the intent dependency determination software application 278, via the machine learning model requesting module 272 and loaded by the machine learning model loading module 274, may include a capability intent action policy-to-capability ML model algorithm 275.

In an embodiment, the intent action policy-to-capability ML model algorithm 275 that receives a name or natural language description for the capability intent action policy as an input and generates a policy vector value. The intent action policy-to-capability ML model algorithm 275 may then correlate, through a semantic similarity comparison or lexical comparison, the capability intent action policy natural language description or policy vector value with one or more capability descriptions or capability intent values to identify a capability intent action that is associated with one or more AI productivity tool-enablable software applications 290 that may be affected by the capability intent policy received. A semantic similarity comparison score or a lexical comparison score may be required to meet a threshold level of correlation between the capability intent action policy and the capability for a determination to be made that the capability intent action policy applies to the capability of one or more AI productivity tool-enablable software applications 290 in some embodiments. A hardware processor 202 executes computer readable code instructions for the intent action policy-to-capability ML model algorithm 275 including a semantic or keyword similarity comparison algorithm to compare the available capabilities of AI productivity tool module 258 on this managed information handling system with the received capability intent action policy via a natural language description or intent value of that received capability intent action.

These correlations by intent action policy-to-capability ML model algorithm 275 are output to the intent dependency determination software application 278 to determine when an indication of the capability dependencies of capabilities for each of a plurality of AI productivity tool-enablable software applications and AI productivity tool modules have a high enough correlation for the received capability intent action to be applied to the capability identified as output from the intent action policy-to-capability ML model algorithm 275. The capabilities that semantically or lexically correlate to the capability intent action policy are those affected by the capability intent action policies. After identifying these capability dependencies, the intent dependency determination software application 278 may pass these capability dependencies on to the policy control managing subagent 280 in an embodiment. The policy control managing subagent 280 transmits the capability intent action policies to the AI productivity tool-enablable software applications and AI productivity tool modules for application of the capability intent action policies that apply to manage impacts of the received capability intent action policies on those capability dependencies at the managed information handling system as described herein.

The identification of capability dependencies associated with any of the AI productivity tool-enablable software applications 290 that could be affected by the capability intent action policies are then passed onto a policy control managing subagent 280. The execution of the computer-readable program code instructions of the policy control managing subagent 280 may transmit the capability intent action policies to the AI productivity tool-enablable software applications 290 and AI productivity tool module 258 for application of the capability intent action policies in order to manage impacts of the capability intent action policies on any responsive capability intent actions to user query input at the information handling system 200.

In an embodiment, the execution of the computer-readable program code instructions of the intent dependency determination software application 278 may cause each of the capability intent action policies to be stored on an AI productivity tool policy database 282. In an embodiment, these capability intent action policies may be associated with an AI productivity tool module or AI productivity tool-enablable software application with specific capabilities that have capability dependencies for each capability intent action policy within the AI productivity tool policy database 282 and that may be affected by the individual capability intent action policies. The AI productivity tool policy database maintains the capability intent action policies as well as mappings of the capability intent action policies and capability dependencies relative to their respective AI productivity tool-enablable software applications or AI productivity tool modules at the information handling system. The AI productivity tool policy database may determine from the mappings of the capability intent action policies and capability dependencies relative to their respective AI productivity tool-enablable software applications or AI productivity tool modules at the information handling system when a capability intent action is requested that is subject to a capability intent action policy to apply limitations, adjustments, or expansion of the capability intent action pursuant to the corresponding, received capability intent action policy.

The systems and methods described herein cause the capability intent action policies to be applied to the operations of each of the managed information handling systems 200-1, 200-2, 200-3 such that those capability intent action policies created by the ITDM are used control the impacts on the hardware, software, and firmware resources utilized by capability intent actions at the managed information handling systems 200-1, 200-2, 200-3. Execution of the capability intent action policies by a hardware processor expand or limit the user's query input that can trigger a responsive capability intent action to change service, hardware or software operation, response, or other function in response to the user-query input associated with the information handling systems 200-1, 200-2, 200-3. The systems and methods described in embodiments herein further allow the ITDM to prevent any or reduce adverse impacts due to the user of the information handling system 200-1, 200-2, 200-3 engaging with the AI productivity tool module 258 and/or AI productivity tool subagent 262.

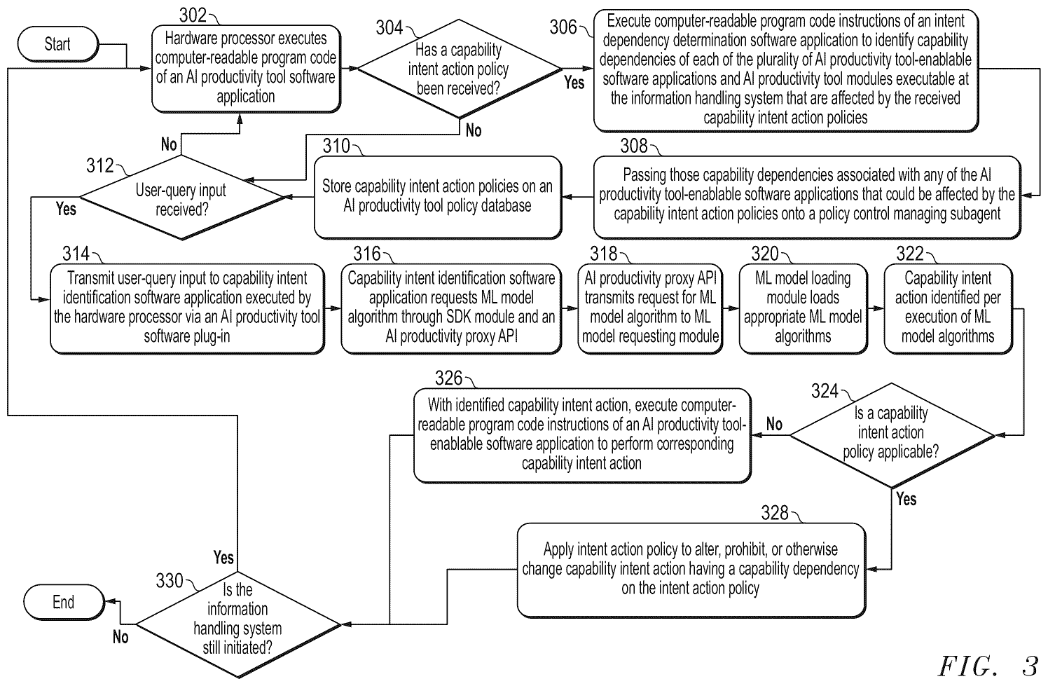

FIG. 3 is a flow diagram showing a method 300 implementing capability intent action policies with operation of an AI productivity tool module in an information handling system according to an embodiment of the present disclosure. The method 300 described in connection with FIG. 3 may be operated on an information handling system such as an information handling system (e.g., 100, 200) described in connection with FIG. 1 or 2. In an embodiment, the information handling system may be one of a plurality of information handling systems within an enterprise. In an embodiment, an ITDM may be responsible for generating capability intent action policies for application on these information handling systems within the enterprise as described in embodiments herein.

The method 300 may include, at block 302, the hardware processor or other hardware processing device of the information handling system executing computer-readable program code instructions of an AI productivity tool module including access to one or more AI productivity tool software applications executing on the information handling system. In an embodiment, AI productivity tool module may be any application that can receive input from a user such as text input via the keyboard or speech input via the microphone. In some embodiments, text or audio may be received by an interface of the one or more AI productivity tool software applications and the interface managed by the AI productivity tool module. In an embodiment, the AI productivity tool module may include a virtual assistant-type AI software agent. In various embodiments, the hardware processor or other alternative hardware processing resources of the information handling system may execute computer-readable program code instructions of the AI productivity tool software application or AI productivity tool module with its AI productivity tool software plug-in and monitor for user-query inputs at a microphone, keyboard, or other input device for the AI productivity tool subagent to engage in Capability intent actions pursuant to the user-query inputs.

As described herein, the ITDM may generate one or more capability intent action policies via a remotely located ITDM content delivery network and a remote policy management server used to manage one or more managed information handling systems. At block 304, the method 300 includes determining whether one or more capability intent action policies have been received at the information handling system. As described in embodiments herein, in order to control the specific operation of any given managed information handling system within an enterprise in responding to user-query inputs received via text or audio to trigger one or more AI productivity tool enablable software applications at managed information handling systems, an ITDM may generate any number of capability intent action policies. These capability intent action policies may be transmitted down from a remote policy management server to a plurality of information handling systems to effectuate those policies as directed by the ITDM or other policy generating entity at each of the managed information handling systems.

In an example embodiment, an ITDM may access an ITDM content delivery network in order to generate these capability intent action policies for transmission down to each of the managed information handling systems. Thus, in an embodiment, an ITDM may be presented with a GUI on the remote policy management server that is executing the computer-readable program code of the ITDM content delivery network to generate these capability intent action policies. In an embodiment, the ITDM content delivery network may be provided with specific details of each of the managed information handling systems within the enterprise by accessing a capabilities and device inventory database. The capabilities and device inventory database may provide data about each of the information handling systems within the enterprise, the AI productivity tool-enablable software applications and ML mode algorithms executing or executable on those information handling systems as well as other features of the hardware, software, and firmware of each information handling system within the enterprise in order to be made aware of which capability intent action policies are to be distributed down to which information handling system within the enterprise. These ITDM generated capability intent policies may or may not be transmitted to a managed information handling system. Where no capability intent action policies have been received at block 304, the method 300 may proceed to block 312 to determine if a user-query input is received by the AI productivity tool module as described herein. Where one or more capability intent action policies have been received at block 304, the method 300 may proceed to block 306 to determine a capability intent dependency determination to correlate the received capability intent action policy to one or more capabilities of AI productivity tool enablable software applications or functions of the AI productivity tool module on the managed information handling system.

At block 306, the method 300 includes executing computer-readable program code instructions of an intent dependency determination software application. Execution of the computer readable program code instructions of the intent dependency determination software application identifies capability dependencies of each of the plurality of AI productivity tool-enablable software applications and functions of the AI productivity tool modules themselves executable at the information handling system that are affected by the capability intent action policies as the capability intent action policies are received at the information handling system. For example, the ITDM may create a capability intent action policy that enables or disables capabilities associated with one or more of the AI productivity tool-enablable software applications so that those AI productivity tool-enablable software applications are prevented from or mandated to execute a service, hardware or software operation, response, or other function in response to a user-query input. A specific example, the ITDM may have created a capability intent action policy that prevents the user from requesting that certain security changes be made to the operations of the information handling system. This capability intent action policy may be transmitted to the intent dependency determination software application being executed by a hardware processor which then identifies capabilities associated with any AI productivity tool-enablable software applications (e.g., Dell® Trusted Device® software application, Dell® Display and Peripheral Manager® software application, Dell® Support Assist® software application) that currently allow for the user to change security settings.

It is appreciated that because a capability intent action policy may be any type of policy, it may apply to plural capabilities associated with any AI productivity tool-enablable software application or functions of the AI productivity tool module. Thus, correlating the received capability intent action policies to the various capabilities it may be applied to may be necessary. In particular, the received capability intent action policies may be broadly determined by the ITDM for a fleet of managed information handling systems which may have varied collections of capabilities of any AI productivity tool-enablable software applications executing thereon in embodiments herein. For example, the capability intent action policies may include a hardware processor intent action policy that describes allowed and disallowed processors that may be used by the AI productivity tool-enablable software applications and AI productivity tool modules executing one or more ML models to provide responsive capability intent actions to a user-query input. In another example embodiment, the capability intent action policies may include a capability-limiting intent action policy that describes capabilities available from the AI productivity tool-enablable software applications and AI productivity tool modules that are to be allowed or disallowed to be implemented. In a further example embodiment, the capability intent action policies may include a provider-limiting intent action policy that describes if and when the information handling system may transmit and receive data over a wired or wireless connection to a server executing the computer-readable program code instructions of the AI productivity tool-enablable software applications and AI productivity tool modules on behalf of the information handling system. In still a further example, the capability intent action policies may include an updating intent actions policy that describes if and when to request updates to the capability intent action policies and how to map the capability intent action to the capabilities associated with each of the AI productivity tool-enablable software applications and AI productivity tool modules.

At block 308, the method 300 further includes passing those capability dependencies associated with any of the AI productivity tool-enablable software applications that could be affected by the capability intent action policies onto a policy control managing subagent. The execution of the computer-readable program code instructions of the policy control managing subagent may also transmit the capability intent action policies to an identified AI productivity tool-enablable software application and AI productivity tool module determined to be affected by one or more of the capability intent action policies. By transmitting these capability intent action policies to the affected AI productivity tool module and AI productivity tool-enablable software applications, the capability intent action policies are applied to individual AI productivity tool-enablable software applications and AI productivity tool modules in order to manage impacts of the capability intent action policies at the information handling system.

At block 310, the method 300 includes storing the capability intent action policies on an AI productivity tool policy database at the information handling system. In an embodiment, the execution of the computer-readable program code instructions of the intent dependency determination software application may cause each of the capability intent action policies to be stored on an AI productivity tool policy database so that these capability intent action policies can remain available to the intent identification software application and intent dependency determination software application for application during determination of and execution of capability intent actions by the AI productivity tool module. In an embodiment, these capability intent action policies may be associated with an AI productivity tool module or AI productivity tool-enablable software application and its capabilities within the AI productivity tool policy database that may be affected by the individual capability intent action policies.

The AI productivity tool policy database maintains the capability intent action policies as well as mappings of the capability intent action policies and capability dependencies relative to their respective AI productivity tool-enablable software applications or AI productivity tool modules at the information handling system. In this way, when a capability intent action is requested, the AI productivity tool policy database may determine from the mappings of the capability intent action policies and capability dependencies relative to their respective AI productivity tool-enablable software applications or AI productivity tool modules at the information handling system when to apply limitations, adjustments, or expansion of the capability intent action pursuant to the corresponding, received capability intent action policy.

The storage of the capability intent action policies on the information handling system allows the capability intent action policies to affect the services, hardware or software operation, response, or other function in response to a user-query input without being operatively coupled to the remote policy management server. Thus, in an embodiment, the ITDM may generate the capability intent action policies that are executed at the information handling systems within the enterprise without having to constantly monitor or provide resources for the execution of the capability intent action policies.

The method 300 also includes determining, at block 312, whether any user-query input has been received. Where, at block 312, no user-query input is received, the method 300 returns to block 302 with the AI productivity tool software application continuing to monitor for this input. Where, at block 312, the AI productivity tool software application does detect and receive user-query input, the method 300 continues to block 314 with the user-query input being transmitted to an intent identification software application being executed by the hardware processor of the information handling system via an AI productivity tool software plug-in. In an embodiment, the intent identification software application may be part of an AI productivity tool subagent that provides AI productivity services as described herein.

Proceeding to block 316, the hardware processor executing computer readable code instructions of the intent identification software application may request an ML model algorithm though the SDK module and an AI productivity proxy API. The intent identification software application may engage with a machine learning model requesting module to have one or more ML model algorithms loaded and executed on the hardware processor in order to, initially, process received query inputs and determine the capability intent action to be conducted based on the received user-query inputs. The execution of the computer-readable program code instructions of the intent identification software application may call the SDK module. The SDK module may include any computer-readable program code instructions that is executed by the hardware processor or other hardware processing resource to request that a ML model algorithm be invoked to support processing a user input query and then an identification of a capability intent action responsive to the received user-query inputs from a user.

At block 318, the AI productivity proxy API transmits the request for the ML model algorithm to ML model requesting module. The intent identification software application may engage with a machine learning model requesting module to have one or more ML model algorithms loaded and executed on the hardware processor in order to, initially, determine the query intent value to correlate with a capability intent action to be conducted responsive to the received user-query inputs.

At block 320, the ML model loading module loads the appropriate ML model algorithms. For example, the ML model algorithm may include a query input-to-intent ML model algorithm that receives the user-query inputs, identifies a user-query intent or description of the user-query inputs, and generates a multi-axis vector query intent value for the identified user-query intent as a function of the AI productivity tool module. The ML model algorithm may also include a query intent-to-capability matching ML model algorithm that receives the generated multi-axis vector query intent value of an input query as input and matches the assigned multi-axis vector query intent value to a capability intent value associated with the AI productivity tool-enablable software application that can execute the capability intent action as identified as responsive to a query input at block 322. Execution of computer-readable program code instructions for a query intent-to-capability matching ML model algorithm may conduct a semantic similarity comparison between a vector query intent value and one or more vector capability intent values of available capabilities at the information handling system to determine a statistical correlation or a closeness of vector values within a threshold. A correlation at a threshold level between the query intent value and a capability intent value indicates a capability that is responsive to a user-query input.

It is appreciated that the selected ML model algorithms satisfy an interface contract requested by the intent identification software application such that the query intent value from the user-query inputs may be generated and similarity correlation to a capability intent value for a capability associated with one of the plurality of AI productivity tool-enablable software applications can be matched to the user-query input from the user. The interface contract described herein defines the requirements that selected ML model algorithms are to have in order to be able receive a specific type of input from the intent identification software application or any AI productivity tool-enablable software application and to provide a specific type of output to the intent identification software application and/or AI productivity tool-enablable software applications. In an embodiment, the interface contract is generated by an AI productivity proxy API invoked by the SDK module in order to identify the specific ML model algorithm that provides the appropriate output to the intent identification software application.

At the point where the capability intent action has been identified at block 322, the method 300 may proceed to block 324 with the execution of computer readable code instructions of the policy control managing subagent determining whether a capability intent action policy is found to be applicable to the identified capability intent for a capability intent action responsive to a user-query input. As described herein, this identification of capability dependencies associated with any of the AI productivity tool-enablable software applications that could be affected by the capability intent action policies are passed onto a policy control managing subagent and stored in the AI productivity tool policy database. The execution of the computer-readable program code instructions of the policy control managing subagent, for example, may transmit the capability intent action policies to the AI productivity tool-enablable software applications and AI productivity tool module for application of the capability intent action policies in order to manage impacts of the capability intent action policies at the information handling system when such a capability intent action policy is deemed applicable to a capability of that AI productivity tool-enablable software application or to a function of the AI productivity tool module.

Thus, where no capability intent action policy is applicable to a determined responsive capability intent action, the method proceed to block 326. At block 326, the one or more capability intent actions determined to not have an applicable capability intent action policy may be completed based on a correlated response to the user-query input. Examples of capability intent actions may include hardware or software operations or setting, software service or other responses. Examples of such capability intent actions may include changing a brightness level of a video display device via execution of a Dell® Display and Peripheral Manager® software application, updating drivers via execution of the Dell® Optimizer® software application, pairing a Bluetooth device securely via execution of the Dell® Trusted Device® software application, facilitating a gaming mode via execution of an Alienware® Command Center (AWCC) software application, providing warranty information or providing instructions to replace hardware within the information handling system via execution of a Dell® Support Assist® software application, among other capability intent actions.

Returning to block 324, where it is determined that a capability intent action policy is applicable, the method 300 continues to block 328. At block 328, the execution of computer readable code instructions of the policy control managing subagent may issue instructions to an AI productivity tool-enablable software application or the AI productivity tool module to apply those instructions or settings required by the intent action policy to alter, prohibit, or otherwise change the capability intent action having a capability dependency on that received intent action policy in embodiments herein. This may result in the user's original user-query input not resulting in a change in the operations of the hardware, software, and firmware resources utilized by capability intent actions at the information handling system that may limit, prevent, or expand the capabilities of the information handling system based on the requirements received in applicable capability intent action policies received. For example, an instruction may be provided by the computer readable code instructions of the policy control managing subagent to AI productivity tool-enablable software application to prohibit communication with an identified external, remote data source or data server or with any remote resources during any execution of the capability intent action for security reasons in an embodiment. In another example embodiment, an instruction may be provided by the computer readable code instructions of the policy control managing subagent to AI productivity tool-enablable software application to instruct communication only with an authorized, identified external remote resource any execution of the capability intent action for security reasons in an embodiment. Other example embodiments may involve for limiting, adjusting, expanding or otherwise implementing controls from the policy control managing subagent to AI productivity tool-enablable software application to limit, adjust, or expand hardware or software operations, software services, or responses during execution of responsive capability intent actions in accordance with the received capability intent actions received.

At block 330, the method 300 includes determining if the information handling system is still initiated. Where the information handling system is still initiated, the method 300 proceeds to block 302 as described herein. Where the information handling system is no longer initiated, the method 300 may end here.

The blocks of the flow diagrams of FIG. 3 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system comprising:
a hardware processor executing computer-readable program code instructions of an intent dependency determination software application to receive one or more capability intent action policies describing controls for execution of capability intent actions to be implemented at the information handling system;
the hardware processor executing computer-readable program code instructions to identify one or more capability dependencies by semantic or lexical similarity matching one or more capabilities of a plurality of artificial intelligence (AI) productivity tool-enablable software applications or an AI productivity tool module executable at the information handling system with a first capability intent action policy, where the capabilities are responsive to a user-query input received at the AI productivity tool module with at least one capability intent action; and
the hardware processor executing computer-readable program code instructions of a policy control managing subagent to transmit the first capability intent action policy to the one or more AI productivity tool-enablable software applications or the AI productivity tool module for application of the first capability intent action policy to adjust execution of the at least one intent action pursuant to the first capability intent action policy at the information handling system.

2. The information handling system of claim 1 further comprising:
the first capability intent action policy including a hardware processor intent action policy that describes allowed and disallowed processors that may be used by the AI productivity tool-enablable software applications and AI productivity tool modules executing one or more machine learning (ML) model algorithms to provide responsive capability intent actions to the user-query input.

3. The information handling system of claim 1 further comprising:
the capability intent action policies including a capability-limiting intent action policy that describes capabilities available from the AI productivity tool-enablable software applications or the AI productivity tool module that are to be allowed or disallowed to be implemented.

4. The information handling system of claim 1 further comprising:
the hardware processor to receive the user-query input and execute a semantic similarity comparison to correlate the user query input to a capability intent value for the at least one capability intent action; and
the hardware processor to execute computer readable code instructions of the policy control managing subagent to determine if the first capability intent action policy is associated with the at least one capability intent action from a database storing the mappings of the first capability intent action policy to the at least one capability intent action before applying adjustment to the execution of the at least one capability intent action.

5. The information handling system of claim 1 further comprising:
the hardware processor to receive the user-query input and execute a semantic similarity comparison to correlate the user query input to a capability intent value for a second capability intent action;
the hardware processor to execute computer readable code instructions of the policy control managing subagent to determine if any capability intent action policies are associated with the second capability intent action from a database storing the mappings of the capability intent action policies to the capabilities; and
executing the second capability intent action when no capability intent action policies are associated with the second capability intent action.

6. The information handling system of claim 1 further comprising:
an AI productivity tool policy database that maintains the capability intent action policies and mappings of the capability intent action policies and capability dependencies relative to their respective AI productivity tool-enablable software applications and AI productivity tool modules at the information handling system.

7. The information handling system of claim 1 further comprising:
the hardware processor executing computer-readable program code instructions of an intent identification software application to invoke one or more machine learning (ML) model algorithms to perform the semantic similarity comparison or a lexical similarity comparison for the received capability intent action policies with one or more capabilities of the AI productivity tool-enablable software applications or functions of the AI productivity tool module and identify the capability dependencies of the capability intent action policies to a corresponding capability of the AI productivity tool-enablable software applications or function of the AI productivity tool module.

8. The information handling system of claim 1 further comprising:
the hardware processor executing computer-readable program code instructions of the intent identification software application to invoke a machine learning (ML) model to generate vectorized policy intent value for each of the received intent action policies, generate vectorized capability intent values of each of the capabilities associated with each of the AI productivity tool-enablable software applications, and match the vectorized policy intent values and vectorized capability intent values based on a semantic similarity comparison score to map each of the capability intent action policies with one or more capabilities associated with the AI productivity tool-enablable software applications to identify the one or more capability dependencies.

9. A method of implementing capability intent action policies in an information handling system comprising:
executing computer-readable program code instructions, via a hardware processor, of an intent dependency determination software application to receive a first capability intent action policy of a plurality of capability intent action policies describing controls for execution of capability intent actions to be implemented at the information handling system in response to user query inputs received by an artificial intelligence (AI) productivity tool module;
executing computer readable program code instructions, via the hardware processor, to identify capability dependencies of capabilities of AI productivity tool-enablable software applications or functions of the AI productivity tool module executable at the information handling system that are affected by the capability intent action policies to identify a first capability having a first capability intent action that is correlated to the first capability intent action policy; and
executing computer readable program code instructions of a policy control managing subagent to transmit the first capability intent action policy to the AI productivity tool-enablable software application or the AI productivity tool module for application of the first capability intent action policy to adjust execution of the first capability intent action according to the first capability intent action policy at the information handling system.

10. The method of claim 9 further comprising:
the first capability intent action policy including a provider-limiting intent action policy that describes if and when the information handling system may transmit and receive data over a wired or wireless connection to a remote server to support executing the computer-readable program code instructions of the AI productivity tool-enablable software applications or AI productivity tool module.

11. The method of claim 9 further comprising:
executing computer readable program code instructions, via the hardware processor, to identify capability dependencies of capabilities of AI productivity tool-enablable software applications or functions of the AI productivity tool module executable at the information handling system that are affected by the capability intent action policies by executing a semantic similarity comparison or a lexical similarity comparison between a first capability intent action policy and a plurality of the capabilities to identify a first policy subset of the capabilities to be correlated to the first capability intent action policy; and
executing computer readable program code instructions of a policy control managing subagent to transmit the first capability intent action policy to the AI productivity tool-enablable software applications or the AI productivity tool module for application of the first capability intent action policy to adjust execution of a plurality of capability intent actions for the first policy subset of the capabilities according to the first capability intent action policy at the information handling system.

12. The method of claim 9 further comprising:
receiving the user-query input and executing, via the hardware processor, a semantic similarity comparison to correlate the user query input to a capability intent value for the first capability intent action; and
the hardware processor to execute computer readable code instructions of the policy control managing subagent to determine if the first capability intent action policy is associated with the first capability intent action from a database storing mappings of the first capability intent action policy to the first capability intent action before applying adjustment to the execution of the first capability intent action.

13. The method of claim 9 further comprising:
receiving the user-query input and executing a semantic similarity comparison to correlate the user-query input to a second capability intent action;
determining if any capability intent action policies are associated with the second capability intent action from a database storing the mappings of the capability intent action policies to the capabilities; and
executing the second capability intent action when no capability intent action policies are associated with the second capability intent action.

14. The method of claim 9 further comprising:
storing, at an AI productivity tool policy database, the plurality of capability intent action policies and mappings of the capability intent action policies and capability dependencies relative to their respective AI productivity tool-enablable software applications and the AI productivity tool module at the information handling system.

15. The method of claim 9 further comprising:
executing computer-readable program code instructions of an intent identification software application to invoke one or more machine learning (ML) model algorithms to map the plurality of capability intent action policies with one or more of the AI productivity tool-enablable software applications or the AI productivity tool module and identify the capability dependencies of the capability intent action policies to the AI productivity tool-enablable software applications and AI productivity tool modules.

16. The method of claim 9 further comprising:
executing computer-readable program code instructions of the intent identification software application to invoke a machine learning (ML) model to generate vectorized policy intent value for each of the plurality of capability intent action policies received, generate vectorized capability intent values of each of the capabilities associated with each of the AI productivity tool-enablable software applications or the AI productivity tool module, and match the vectorized intent action policy values and vectorized capability intent values to identify capability dependencies of each of a plurality of AI productivity tool-enablable software applications and the AI productivity tool module executable at the information handling system.

17. An information handling system comprising:
a hardware processor executing computer-readable program code instructions of an intent dependency determination software application to receive one or more capability intent action policies describing controls to be implemented for execution of capability intent actions responsive to a user-query input received at an artificial intelligence (AI) productivity tool module executing at the information handling system;
the hardware processor executing computer-readable program code instructions of the intent dependency determination software application to identify capability dependencies of each of a plurality of AI productivity tool-enablable software applications executable at the information handling system that are affected by the one or more capability intent action policies;
the hardware processor to map each of the capability intent action policies with an affected capability associated with each of the AI productivity tool-enablable software applications in an AI productivity tool policy database memory at the information handling system; and
the hardware processor executing computer-readable program code instructions of a policy control managing subagent to transmit the capability intent action policies to the AI productivity tool-enablable software applications for application of the capability intent action policies to adjust execution of a plurality of capability intent actions by capabilities of the AI productivity tool-enablable software applications pursuant to a corresponding capability intent action policy at the information handling system.

18. The information handling system of claim 17 further comprising:
the hardware processor to receive the user-query input and execute a semantic similarity comparison to correlate the user query input to a capability intent value for a capability intent action by execution of a machine learning (ML) model algorithm by generating vectorized policy intent values for each of the received capability intent action policies, by generating vectorized capability intent values of each of the capabilities associated with each of the AI productivity tool-enablable software applications, and matching the vectorized intent action policy values and vectorized capability intent values via a similarity comparison score between each of the vectorized policy intent values and the vectorized capability intent values; and
the hardware processor to execute computer readable code instructions of the policy control managing subagent to determine if any capability intent action policies are associated with the capability intent action from AI productivity tool policy database memory storing mappings of the capability intent action policies to the capabilities to determine that a first capability intent action policy applies to the capability intent action and limiting the execution of the capability intent action pursuant to the first capability intent action policy.

19. The information handling system of claim 17 further comprising:
the hardware processor to receive the user-query input and execute a semantic similarity comparison to correlate the user query input to a capability intent value for a capability intent action;
the hardware processor to execute computer readable code instructions of the policy control managing subagent to determine if any capability intent action policies are associated with the capability intent action from the AI productivity tool policy database memory storing the mappings of the capability intent action policies to the capabilities; and
executing the capability intent action when no capability intent action policies are associated with the capability intent action.

20. The information handling system of claim 17 further comprising:
the capability intent action policies including a provider-limiting intent action policy that describes if and when the information handling system may transmit and receive data over a wired or wireless connection to a remote server supporting executing the computer-readable program code instructions of the AI productivity tool-enablable software applications.
